(19) United States
(12) Patent Application Publication
(10) Pub. No.: US 2025/0062424 A1
(43) Pub. Date: Feb. 20, 2025

(54) BATTERY MOVEMENT DETECTION APPARATUS AND BATTERY MONITORING SYSTEM INCLUDING THE SAME

(71) Applicant: LG ENERGY SOLUTION, LTD., Seoul (KR)

(72) Inventors: Hu Jun LEE, Daejeon (KR); Sang Hoon LEE, Daejeon (KR); Moon Koo CHUNG, Daejeon (KR); Jung Hoon LEE, Daejeon (KR); Jung Hyun KWON, Daejeon (KR); Duk You KIM, Daejeon (KR); Seok Hyeong HAM, Daejeon (KR)

(73) Assignee: LG ENERGY SOLUTION, LTD., Seoul (KR)

(21) Appl. No.: 18/563,769

(22) PCT Filed: Nov. 2, 2022
(86) PCT No.: PCT/KR2022/017048

§ 371 Date: Nov. 22, 2023

(30) Foreign Application Priority Data
Nov. 24, 2021 (KR) 10-2021-0163806

(51) Int. Cl. H01M 10/42; H02J 7/00

(52) U.S. Cl. CPC H01M 10/4285; H02J 7/00032; H02J 7/0048; H02J 7/005; H02J 7/007192

(57) ABSTRACT

Discussed is a battery movement detection apparatus that may include a speed sensor configured to obtain speed information of a tray accommodating a battery, a power supply unit configured to provide a driving power, an environment sensor configured to obtain environment information about a surrounding environment of the battery movement detection apparatus, a communication unit configured to transmit the speed information to a battery position detection apparatus, and a controller configured to calculate an available limit of the power supply unit based on the environment information and control an operation of the communication unit based on the available limit of the power supply unit.

### CROSS-REFERENCE TO RELATED APPLICATION

This application claims priority to and the benefit of Korean Patent Application No. 10-2021-0163806 filed in the Korean Intellectual Property Office on Nov. 24, 2021, the entire contents of which are incorporated herein by reference.

### TECHNICAL FIELD

Embodiments disclosed herein relate to a battery movement detection apparatus and a battery monitoring system including the same.

### BACKGROUND ART

Recently, as the demand for portable electronic products such as laptop computers, video cameras, and mobile phones has increased rapidly, and development of electric vehicles, batteries for energy storage, robots, satellites, etc., has hit its stride, research on high-performance batteries that are repeatedly chargeable and dischargeable is being actively conducted.

Current commercially available batteries include nickel cadmium batteries, nickel hydride batteries, nickel zinc batteries, lithium batteries, and so forth, among which the lithium batteries are in the limelight due to their advantages of freely being charged and discharged due to little memory effect, very low self-discharge rate, and high energy density, compared to nickel-based batteries.

In a process of producing such a battery, the battery is moved through a logistics moving device such as a conveyor belt, etc.

### DISCLOSURE

### Technical Problem

During the logistics movement of the battery, when impact occurs on a tray accommodating the battery or congestion section of the logistics movement occurs, the battery may be damaged, resulting in degradation of performance and quality of the battery product. Thus, in a battery production process, it is important to detect in real time whether impact has been applied to the battery or whether there is congestion in the battery logistics movement by detecting the logistics movement of the battery. At this time, when the impact is detected on the battery or there is the congestion in the logistics movement of the battery, it is necessary to track a location of the battery in real time as well.

### Technical Solution

A battery movement detection apparatus according to an embodiment disclosed herein includes a speed sensor configured to obtain speed information of a tray accommodating a battery, a power supply unit configured to provide a driving power, an environment sensor configured to obtain environment information about a surrounding environment of the battery movement detection apparatus, a communication unit configured to transmit the speed information to a battery position detection apparatus, and a controller configured to calculate an available limit of the power supply unit based on the environment information and control an operation of the communication unit based on the available limit of the power supply unit.

According to an embodiment, the controller may be further configured to transmit the speed information to the battery position detection apparatus in a communication period, and adjust the communication period based on the available limit of the power supply unit.

According to an embodiment, the speed sensor may include at least one of an acceleration sensor and an angular speed sensor.

According to an embodiment, the environment information may include at least one of temperature information and humidity information.

According to an embodiment, the controller may be further configured to calculate a diagnosis coefficient based on the environment information and calculate the available limit of the power supply unit based on the diagnosis coefficient, a capacity of the power supply unit, a consumed current required for the communication unit to transmit the speed information to the battery position detection apparatus, and a communication time of the communication unit.

According to an embodiment, the controller may be further configured to increase the communication period when the available limit of the power supply unit is less than a reference value.

In a battery monitoring system including a battery movement detection apparatus, a battery position detection apparatus, and a server, according to an embodiment disclosed herein, the battery movement detection apparatus includes a speed sensor configured to obtain speed information of a tray accommodating a battery, a first power supply unit configured to provide a driving power, a first environment sensor configured to obtain first environment information about a surrounding environment of the battery movement detection apparatus, a first communication unit configured to transmit the speed information to the battery position detection apparatus, and a first controller configured to calculate an available limit of the first power supply unit based on the first environment information and control an operation of the first communication unit based on the available limit of the first power supply unit, and the battery position detection apparatus includes a distance measurement unit configured to obtain distance information with the battery movement detection apparatus and a second communication unit configured to transmit the speed information and the distance information to the server, and the server is configured to calculate an amount of impact of the battery movement detection apparatus based on the speed information and track a position of the battery movement detection apparatus based on the distance information.

According to an embodiment, the first communication unit may be further configured to transmit the speed information to the battery position detection apparatus in a first communication period, and the first controller may be further configured to increase the first communication period when the available limit of the first power supply unit is less than a first reference value.

According to an embodiment, the server may be further configured to generate a first alert message when the available limit of the first power supply unit is equal to or greater than the first reference value and is less than a second reference value.

According to an embodiment, the first controller may be further configured to calculate a first diagnosis coefficient based on the first environment information and calculate the available limit of the first power supply unit based on the first diagnosis coefficient, a capacity of the first power supply unit, a consumed current required for the first communication unit to transmit the speed information to the battery position detection apparatus, and a communication time of the first communication unit.

According to an embodiment, the battery position detection apparatus may include a second power supply unit configured to provide a driving power, a second environment sensor configured to obtain second environment information about a surrounding environment of the battery position detection apparatus, and a second controller configured to calculate an available limit of the second power supply unit based on the second environment information and control an operation of the second communication unit based on the available limit of the second power supply unit.

According to an embodiment, the second environment information may include at least one of temperature information and humidity information.

According to an embodiment, the second communication unit may be further configured to transmit the speed information and the distance information to the server in a second communication period, and the second controller may be further configured to adjust the second communication period based on the available limit of the second power supply unit.

According to an embodiment, the second controller may be further configured to calculate a second diagnosis coefficient based on the second environment information and calculate the available limit of the second power supply unit based on the second diagnosis coefficient, a capacity of the second power supply unit, a consumed current required for the second communication unit to transmit the speed information and the distance information to the server, and a communication time of the second communication unit.

According to an embodiment, the second controller may be further configured to increase the second communication period when the available limit of the second power supply unit is less than a third reference value.

According to an embodiment, the server may be further configured to generate a second alert message when the available limit of the second power supply unit is equal to or greater than the third reference value and is less than a fourth reference value.

An operating method of a battery movement detection apparatus according to an embodiment disclosed herein includes obtaining speed information of a tray accommodating a battery, obtaining surrounding environment information of the battery movement detection apparatus, transmitting the speed information to another device in a communication period, calculating an available limit of a power supply unit based on the surrounding environment information, and adjusting the communication period based on the available limit of the power supply unit.

According to an embodiment, the operation method may further include calculating a diagnosis coefficient based on the surrounding environment information and measuring a consumed current and a communication time required for transmitting the speed information to the another device, in which the available limit of the power supply unit is calculated based on the capacity of the power supply unit, the consumed current, the communication time, and the diagnosis coefficient.

According to an embodiment, the operation method may further include increasing the communication period when the available limit of the power supply unit is less than a reference value.

According to an embodiment, the speed information may include at least one of acceleration information and angular speed information.

According to an embodiment, the surrounding environment information may include at least one of temperature information and humidity information.

### Advantageous Effects

A battery movement detection apparatus according to the disclosure of the present document may detect whether impact occurs due to the logistics movement of a battery and whether congestion is occurring in the logistics movement of the battery.

A battery movement detection apparatus and/or a battery position detection apparatus according to the disclosure of the present document may calculate the available capacity of a power supply unit providing driving power to diversify an operation based on the calculated available capacity, thereby preventing an operation from being stopped due to a shortage of voltage supply and managing the same.

A battery monitoring system according to the disclosure of the present document may monitor the amount of impact applied to the battery and/or the position of the battery when the impact occurs according to the logistics movement of the battery or congestion occurring in the logistics movement of the battery.

The effects of the battery movement detection apparatus and the battery monitoring system according to the disclosure of the present document are not limited to the effects mentioned above, and other effects not mentioned will be clearly understood by those of ordinary skill in the art according to the disclosure of the present document.

### DESCRIPTION OF DRAWINGS

FIG. 1 shows a tray and a battery movement detection apparatus according to an embodiment disclosed herein;

FIG. 2 shows a monitoring system according to an embodiment disclosed herein.

FIG. 3 shows a battery position detection apparatus according to an embodiment disclosed herein.

FIG. 4 is a flowchart illustrating an operating method of a battery monitoring system according to an embodiment disclosed herein.

FIG. 5 is a flowchart illustrating in detail an operating method of a battery monitoring system according to an embodiment disclosed herein.

FIG. 6 is a flowchart illustrating in detail an operating method of a battery monitoring system according to an embodiment disclosed herein.

With regard to the description of the drawings, similar reference numerals may be used to refer to similar or related components.

### MODE FOR INVENTION

Hereinafter, various embodiments of the present disclosure will be disclosed with reference to the accompanying drawings. However, the description is not intended to limit the present disclosure to particular embodiments, and it should be construed as including various modifications, equivalents, and/or alternatives according to the embodiments of the present disclosure.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. Such terms as “1^{st}”, “2^{nd},” “first”, “second”, “A”, “B”, “(a)”, or “(b)” may be used to simply distinguish a corresponding component from another, and does not limit the components in other aspect (e.g., importance or order), unless mentioned otherwise.

Herein, it is to be understood that when an element (e.g., a first element) is referred to, with or without the term “operatively” or “communicatively”, as “connected with”, “coupled with”, or “linked with”, or “coupled to” or “connected to” to another element (e.g., a second element), it means that the element may be connected with the other element directly (e.g., wiredly), wirelessly, or via a third element.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store, or between two user devices directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

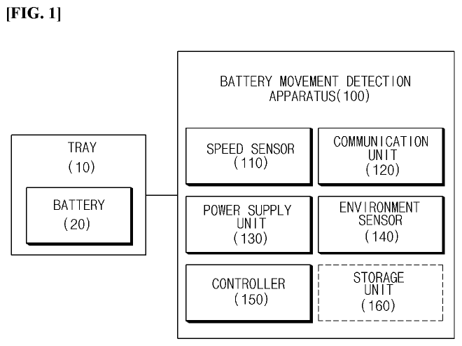

FIG. 1 shows a tray and a battery movement detection apparatus according to an embodiment disclosed herein.

Referring to FIG. 1, a tray 10 may accommodate a battery 20. The battery movement detection apparatus 100 may be connected to the tray 10. The battery movement detection apparatus 100 may detect movement of the tray 10. Thus, the battery movement detection apparatus 100 may detect movement of the battery 20 accommodated in the tray 10.

The battery movement detection apparatus 100 according to an embodiment disclosed herein may include a speed sensor 110, a communication unit 120, a power supply unit 130, an environment sensor 140, and a controller 150. The battery movement detection apparatus 100 may further include a storage unit 160.

The speed sensor 110 may obtain information for detecting impact of the battery movement detection apparatus 100. According to an embodiment, the speed sensor 110 may obtain speed information of the tray 10. The speed sensor 110 may include an acceleration sensor and/or an angular speed sensor. According to an embodiment, the angular speed sensor may include a gyro sensor.

The communication unit 120 may communicate with another electronic device. According to an embodiment, the communication unit 120 may perform ultra-wideband (UWB) wireless communication. The communication unit 120 may communicate with another electronic device in every preset communication period. The communication unit 120 may transmit the speed information obtained by the speed sensor 110 to another device or server other than the battery movement detection apparatus 100.

According to an embodiment, the communication unit 120 may operate in a wake-up mode corresponding to a communication period. The communication unit 120 may operate in a sleep mode after communication with another electronic device in a communication period. When the communication unit 120 operates in the sleep mode, the battery movement detection apparatus 100 may reduce power consumption. According to an embodiment, the communication unit 120 may be controlled in an operation thereof by the controller 150. For example, the communication period of the communication unit 120 may be controlled by the controller 150.

The power supply unit 130 may provide a driving power to the battery movement detection apparatus 100. According to an embodiment, the power supply unit 130 may provide a driving power to the speed sensor 110, the communication unit 120, the environment sensor 140, the controller 150, and/or the storage unit 160. According to an embodiment, the capacity of the power supply unit 130 may be limited. The power supply unit 130 may be a power storage unit that is not connected to a power source at all times and has a predetermined capacity.

The environment sensor 140 may measure surrounding environment information of the battery movement detection apparatus 100. The surrounding environment information measured by the environment sensor 140 may include temperature information and/or humidity information. For example, the environment sensor 140 may measure the environment information of the power supply unit 130. That is, the environment sensor 140 may measure a temperature and/or humidity around the power supply unit 130.

The controller 150 may control an operation of the communication unit 120. The controller 150 may be communicatively connected to the communication unit 120.

The controller 150 may receive the environment information from the environment sensor 140. The controller 150 may control an operation of the communication unit 120 considering the environment information received from the environment sensor 140. The controller 150 may calculate an available limit of the power supply unit 130 based on the environment information and control an operation of the communication unit 120 based on the calculated available limit. According to an embodiment, the controller 150 may adjust a communication period of the communication unit 120 based on the available limit.

More specifically, the controller 150 may calculate a diagnosis coefficient related to the power supply unit 130 based on the environment information. The controller 150 may calculate the available limit of the power supply unit 130 based on the diagnosis coefficient. Herein, the diagnosis coefficient may be calculated based on the surrounding environment information of the power supply unit 130, and may be understood as a factor related to performance degradation of the power supply unit 130 due to surrounding environment information.

More specifically, the controller 150 may calculate a diagnosis coefficient based on a temperature difference between a preset reference temperature related to the power supply unit 130 and a surrounding temperature of the power supply unit and/or a humidity difference between a preset reference humidity related to the power supply unit 130 and a surrounding humidity of the power supply unit 130. Herein, the reference temperature may be an optimal temperature preset to allow the power supply unit 130 to show optimal performance. Herein, the reference humidity may be an optimal humidity preset to allow the power supply unit 130 to show optimal performance. According to an embodiment, the reference temperature may be set to a room temperature of 25° C., and the reference humidity may be set to 0%, without being limited thereto. The performance of the power supply unit 130 may degrade as the temperature difference between the reference temperature and the surrounding temperature of the power supply unit 130 and/or the humidity difference between the reference humidity and the surrounding humidity of the power supply unit 130 may be large. That is, as the temperature difference and/or humidity difference increases, the amount of power of the power supply unit 130 consumed by the communication unit 120 when the communication unit 120 transmits speed information to another electronic device may increase.

The controller 150 may distinguish a high-temperature section and a low-temperature section based on the reference temperature. The controller 150 may calculate the diagnosis coefficient separately for a case where the temperature of the power supply unit 130 belongs to the low-temperature section and a case where the temperature thereof belongs to the high-temperature section. According to an embodiment, the controller 150 may calculate the diagnostic coefficient such that the diagnostic coefficient is greater when the surrounding temperature of the power supply unit 130 belongs to the low-temperature range than when the surrounding temperature of the power supply unit 130 belongs to the high-temperature range.

In general, the performance of the power supply unit 130 may decrease more at low temperatures than at high temperatures. For example, a performance drop when the temperature of the power supply unit 130 decreases from 25° C. to 0° C. may be greater than a performance drop when the temperature of the power supply unit 130 increases from 25° C. to 50° C. Moreover, when the temperature of the power supply unit 130 is below zero, the performance drop of the power supply unit 130 may further increase. Accordingly, even when a temperature difference than the reference temperature is the same for the case where the surrounding temperature of the power supply unit 130 belongs to the low-temperature section and the case where the surrounding temperature of the power supply unit 130 belongs to the high-temperature section, the controller 150 may calculate the diagnosis coefficient such that the diagnosis coefficient is greater when the surrounding temperature belongs to the low-temperature section than when the surrounding temperature belongs to the high-temperature section.

The controller 150 may calculate the available limit of the power supply unit 130 based on the diagnosis coefficient, the capacity of the power supply unit 130, a consumed current required for the communication unit 120 to transmit the speed information to another electronic device, and the communication time of the communication unit 120.

Herein, the capacity of the power supply unit 130 may be a maximum capacity of the power supply unit 130. According to an embodiment, the capacity of the power supply unit 130 may be a maximum capacity when the power supply unit 130 is in a beginning-of-life (BoL) state. In addition, the consumed current may mean the consumed current required for the communication unit 120 to transmit the speed information to the other electronic device. In addition, the communication time may mean a time required for the communication unit 120 to transmit the speed information to the other electronic device.

Herein, the available limit may be a factor for determining whether the power supply unit 130 is drivable. According to an embodiment, the available limit of the power supply unit 130 may be expressed as an available time. According to an embodiment, the available limit of the power supply unit 130 expressed in the unit of a time may be expressed as the remaining capacity of the power supply unit 130, the number of possible communication of the power supply unit 130, etc., through unit conversion.

For example, the available limit may be configured to decrease as the calculated diagnosis coefficient increases. That is, the available limit of the power supply unit 130 may decrease as the diagnosis coefficient increases.

The controller 150 may calculate the available limit of the power supply unit 130 with reference to Equation 1 below.

$$D = \frac{C}{I} - \sum ( K \times T ) \qquad [ Equation 1 ]$$

In Equation 1, D indicates an available limit, C indicates a maximum capacity of the power supply unit 130, I indicates a consumed current, K indicates a diagnosis coefficient, and T indicates a communication time. According to an embodiment, the unit of C may be [mAh], the unit of I may be [mA], K may be a constant value, and the unit of T may be [s] or [h]. The controller 150 may multiply a proper coefficient for unit conversion to the entire Equation 1 or a part thereof to calculate the available limit D in the unit of a second [s] or an hour [h].

The available limit D calculated using Equation 1 may mean the available time of the power supply unit 130 with respect to the current capacity of the power supply unit 130. The available time of the power supply unit 130 may decrease as the power supply unit 130 operates, i.e., provides a driving power to the communication unit 120. That is, in Equation 1, as a product of the diagnosis coefficient K and the communication time T is accumulated and subtracted for the available limit D, Equation 1 may mean that the available limit D decreases as the power supply unit 130 operates.

Referring to Equation 1, the available limit D may further decrease as the diagnosis coefficient K increases. That is, a drop of the available limit D may increase as the diagnosis coefficient K is calculated large based on the surrounding environment information of the power supply unit 130.

The controller 150 may calculate an available limit of the power supply unit 130 with reference to Equation 1 and control an operation of the communication unit 120 based on the calculated available limit. The controller 150 may determine whether the power supply unit 130 is drivable to control an operation of the communication unit 120. More specifically, the controller 150 may compare the calculated available limit with a reference value and control an operation of the communication unit 120 based on a comparison result.

According to an embodiment, the controller 150 may determine that the power supply unit 130 is drivable when the available limit of the power supply unit 130 is equal to or greater than the reference value. In this case, the controller 150 may maintain the communication period of the communication unit 120.

According to another embodiment, the controller 150 may increase the communication period of the communication unit 120 when the available limit of the power supply unit 130 is less than the reference value. When the available limit of the power supply unit 130 is less than the reference value, this may correspond to a case where the power supply unit 130 may not normally provide a driving power. That is, when the available limit of the power supply unit 130 is less than the reference value, the communication unit 120 may not be communicable with another electronic device according to a preset communication period. Thus, when the available limit of the power supply unit 130 is less than the reference value, the controller 150 may increase the communication period of the communication unit 120 to reduce the frequency of communication of the communication unit 120.

According to an embodiment, when the available limit of the power supply unit 130 is insufficient for providing a sufficient power for an operation of the communication unit 120, the communication unit 120 may not be communicable with another electronic device even when operating in the wakeup mode. According to an embodiment, the controller 150 may calculate the available limit of the power supply unit 130 before the communication unit 120 operates in the wakeup mode.

The controller 150 may control an operation of the communication unit 120. The communication unit 120 may transmit the available limit to the other electronic device. According to an embodiment, the communication unit 120 may transmit the available limit to the other electronic device only when the available limit is equal to or greater than the reference value. According to another embodiment, the communication unit 120 may transmit the available limit to the other electronic device only when the available limit is less than the reference value.

The battery movement detection apparatus 100 according to an embodiment disclosed herein may more accurately determine whether the power supply unit 130 is drivable, by considering not only the consumed current and the communication time required in a communication process and the available capacity of the power supply unit 130 capable of providing a driving power to the communication unit 120, but also surrounding environment information of the power supply unit 130, in calculating the available limit of the power supply unit 130.

The power supply unit 130 of the battery movement detection apparatus 100 according to an embodiment disclosed herein may correspond to a power storage unit having a predetermined capacity and may have performance deviation depending on a surrounding temperature and/or humidity in driving. Thus, the controller 150 may calculate the available limit of the power supply unit 130 and determine whether the power supply unit 130 is drivable, considering the surrounding environment information of the power supply unit 130, thereby preventing an operation of the communication unit 120 from being stopped and/or the power supply unit 130 from being over-discharged over a limit value.

The controller 150 may selectively include a processor, an application-specific integrated circuit (ASIC), other chipsets, a logic circuit, a register, a communication modem, a data processing device, etc., known in this field to execute various control logics performed herein. Thus, when the control logic is implemented as software, the controller 150 may be implemented as a group of program modules. In this case, the program module may be stored in a memory and may be executed by the controller 150. The memory may be inside or outside the controller 150 and may be connected to the controller 150 by well-known various means.

The storage unit 160 may store data or a program required for each component of the battery movement detection apparatus 100 to perform an operation and a function of each component or data, etc., generated in a process of performing the operation and the function. The storage unit 160 may not be specially limited to a specific type as long as it is a well-known information storage means known to record, erase, update, and read data. According to an embodiment, the information storage means may include random access memory (RAM), flash memory, read only memory (ROM), electrically erasable and programmable read only memory (EEPROM), register, etc. In addition, the storage unit 160 may store program codes where processes executable by the controller 150 are defined.

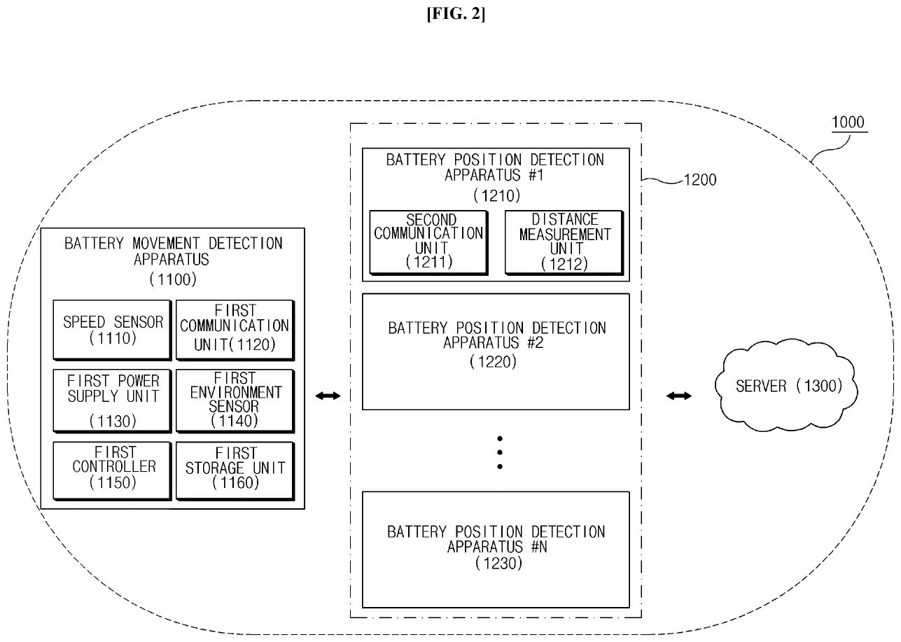

FIG. 2 shows a monitoring system according to an embodiment disclosed herein.

Referring to FIG. 2, a battery monitoring system 1000 according to an embodiment disclosed herein may include a battery movement detection apparatus 1100, a battery position detection apparatus 1200, and a server 1300.

Hereinbelow, the battery monitoring system 1000 will be described in detail with reference to FIG. 1.

The battery movement detection apparatus 1100 may be substantially the same as the battery movement detection apparatus 100 of FIG. 1.

A speed sensor 1110 may have substantially the same configuration as the speed sensor 110 of FIG. 1. The speed sensor 1110 may measure speed information of the battery movement detection apparatus 1100. The speed sensor 1110 may include an acceleration sensor and/or an angular speed sensor. In this case, the angular speed sensor may correspond to a gyro sensor.

A first communication unit 1120 may have substantially the same configuration as the communication unit 120 of FIG. 1. The first communication unit 1120 may communicate with another electronic device. According to an embodiment, the first communication unit 1120 may perform UWB wireless communication. The first communication unit 1120 may transmit speed information to another electronic device in every preset first communication period. The first communication unit 1120 may transmit the speed information obtained by the speed sensor 1110 to another device or server other than the battery movement detection apparatus 1100.

A first power supply unit 1130 may have substantially the same configuration as the power supply unit 130 of FIG. 1. The first power supply unit 1130 may provide a driving power to the battery movement detection apparatus 1100. According to an embodiment, the first power supply unit 1130 may provide a driving power to the speed sensor 1110, the first communication unit 1120, the first power supply unit 1130, a first environment sensor 1140, a first controller 1150, and/or a first storage unit 1160.

The first environment sensor 1140 may have substantially the same configuration as the environment sensor 140 of FIG. 1. The first environment sensor 1140 may measure surrounding environment information of the battery movement detection apparatus 1100. According to an embodiment, the first environment sensor 1140 may measure the surrounding environment information of the first power supply unit 1130.

The first controller 1150 may have substantially the same configuration as the controller 150 of FIG. 1. The first controller 1150 may control an operation of the first communication unit 1120. The first controller 1150 may calculate the available limit of the first power supply unit 1130 based on first environment information.

The first controller 1150 may control an operation of the first communication unit 1120 based on the available limit of the first power source unit 1130. The first controller 1150 may determine whether the available limit of the first power source unit 1130 is less than a first reference value. The first controller 1150 may increase the first communication period when the available limit of the first power source unit 1130 is less than the first reference value.

The first controller 1150 may control an operation of the first communication unit 1120 that may transmit the available limit of the first power source unit 1130 to another electronic device. According to an embodiment, the first communication unit 1120 may transmit the available limit to the other electronic device only when the available limit is equal to or greater than the first reference value. According to another embodiment, the first communication unit 1120 may transmit the available limit of the first power source unit 1130 to the other electronic device only when the available limit of the first power source unit 1130 is less than the first reference value.

The first storage unit 1160 may have substantially the same configuration as the first storage unit 160 of FIG. 1.

The battery position detection apparatus 1200 may include a plurality of battery position detection apparatuses 1210, 1220, and 1230. According to an embodiment, the battery position detection apparatus 1200 may include three or more battery position detection apparatuses. The battery position detection apparatus 1200 may have the same configuration. According to an embodiment, the battery position detection apparatus #1 1210 may include a second communication unit 1211 and a distance measurement unit 1212. A detailed description of the battery position detection apparatus #2 1220 and the battery position detection apparatus #N 1230 may refer to a description of the battery position detection apparatus #1 1210.

The second communication unit 1211 may communicate with another electronic device. According to an embodiment, the second communication unit 120 may perform UWB wireless communication. The second communication unit 1211 may communicate with another electronic device in every preset second communication period.

According to an embodiment, the second communication unit 1211 may operate in the wake-up mode corresponding to the second communication period. The second communication unit 1211 may operate in the sleep mode after communication with the other electronic device in the second communication period. When the second communication unit 1211 operates in the sleep mode, power consumption of the battery position detection apparatus #1 1210 may be reduced. Herein, the other electronic device may mean a device other than the battery position detection apparatus #1 1210 or a server. More specifically, the other electronic device may mean the battery movement detection apparatus 1100, the battery position detection apparatus #2 1220, the battery position detection apparatus #3 1230, and/or the server 1300. The second communication unit 1211 may receive speed information from the first communication unit 1120. The second communication unit 1211 may transmit the speed information to the server 1300.

The distance measurement unit 1212 may obtain distance information between the battery position detection apparatus #1 1210 and the battery movement detection apparatus 1100. The distance measurement unit 1212 may measure a time required for the second communication unit 1211 to transmit a signal to the battery movement detection apparatus 1100 and for the signal to return. The distance measurement unit 1212 may calculate the distance information between the battery position detection apparatus #1 1210 and the battery movement detection apparatus 1100 by using the measured time. The second communication unit 1211 may transmit the distance information to the server 1300. That is, the second communication unit 1211 may the distance information received from the battery movement detection apparatus 1100 and the distance information between the battery position detection apparatus #1 1210 and the battery movement detection apparatus 1100, obtained from the distance measurement unit 1212, together.

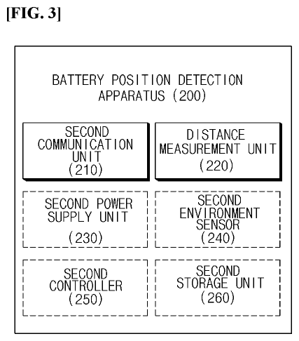

A detailed description of the battery position detection apparatus 1200 will be provided later with reference to FIG. 3.

The server 1300 may calculate the amount of impact of the battery movement detection apparatus 1100 or track the position of the battery movement detection apparatus 1100. According to an embodiment, the server 1300 may receive the speed information of the battery movement detection apparatus 1100 from the battery movement detection apparatus 1100. According to an embodiment, the server 1300 may receive the speed information and/or the distance information between the battery movement detection apparatus 1100 and the battery position detection apparatus 1200 from the battery position detection apparatus 1200.

The server 1300 may calculate the amount of impact of the battery movement detection apparatus 1100 based on the speed information. The speed information may mean acceleration information and/or angular speed information measured by the speed sensor 1110.

The server 1300 may track the position of the battery movement detection apparatus 1100 based on the distance information. The server 1300 may receive distance information from each of the plurality of battery position detection apparatuses 1200. According to an embodiment, the server 1300 may receive measured distance information from each of three or more battery position detection apparatuses. The server 1300 may track the position of the battery movement detection apparatus 1100 based on the received plural distance information. According to an embodiment, the server 1300 may identify the position of the battery movement detection apparatus 1100 based on the received plural distance information through triangulation. According to an embodiment, the server 1300 may track the position of the battery movement detection apparatus 1100 by using a time of arrival (TOA), a time difference of arrival (TDOA), an angle of arrival (AOA), etc.

The server 1300 may receive the available limit of the first power supply unit 1130 from the battery movement detection apparatus 1100 and/or the battery position detection apparatus 1200. The server 1300 may generate a first alert message when the available limit of the first power supply unit 1130 is equal to or greater than the first reference value and is less than a second reference value. The server 1300 may transmit the first alert message to an operator. The first alert message may include available limit information of the first power supply unit 1130. The first alert message may correspond to a message indicating that the battery movement detection apparatus 1100 is in a non-operation risk range. Herein, the non-operation risk range may mean a range in which the battery movement detection apparatus 1100 is likely to stop operating. The first alert message may correspond to a message requesting charge or replacement of the first power supply unit 1130.

FIG. 3 shows a battery position detection apparatus according to an embodiment disclosed herein.

Referring to FIG. 3, the battery position detection apparatus 200 may include a second communication unit 210 and a distance measurement unit 220. The battery position detection apparatus 200 may further include a second power supply unit 230, a second environment sensor 240, a second controller 250, and/or a second storage unit 260.

Hereinbelow, the battery position detection apparatus 200 will be described in detail with reference to FIGS. 1 and 2.

The battery position detection apparatus 200 may have substantially the same configuration as the battery position detection apparatus 1200 of FIG. 2.

The second communication unit 210 may have substantially the same configuration as the second communication unit 1211 of FIG. 2. According to an embodiment, the second communication unit 210 may be controlled in an operation thereof by the second controller 250. For example, the second communication period of the second communication unit 210 may be controlled by the second controller 250.

The distance measurement unit 220 may have substantially the same configuration as the distance measurement unit 1212 of FIG. 2.

The second power supply unit 230 may provide a driving power to the battery position detection apparatus 200. According to an embodiment, the second power supply unit 230 may provide a driving power to the second communication unit 210, the distance measurement unit 220, the second environment sensor 240, the second controller 250, and/or the second storage unit 260. According to an embodiment, the capacity of the second power supply unit 230 may be limited. The second power supply unit 230 may be a power storage unit that is not connected to a power source at all times and has a predetermined capacity.

The second environment sensor 240 may measure surrounding environment information of the battery position detection apparatus 200. The environment information measured by the second environment sensor 240 may include temperature information and/or humidity information. According to an embodiment, the second environment sensor 240 may measure the surrounding environment information of the second power supply unit 230. That is, the second environment sensor 240 may measure a temperature and/or humidity around the second power supply unit 230.

The second controller 250 may control an operation of the second communication unit 210. The second controller 250 may be communicatively connected to the second communication unit 210. The second controller 250 may receive the environment information from the second environment sensor 240.

The second controller 250 may control an operation of the second communication unit 210 considering the environment information received from the second environment sensor 240. The second controller 250 may calculate an available limit of the second power supply unit 230 based on the environment information and control an operation of the second communication unit 210 based on the calculated available limit. According to an embodiment, the second controller 250 may adjust the second communication period of the second communication unit 210 based on the available limit.

More specifically, the second controller 250 may calculate the diagnosis coefficient for the second power supply unit 230 based on the environment information received from the second environment sensor 240. The second controller 250 may calculate the available limit of the second power supply unit 230 based on the diagnosis coefficient. Herein, the diagnosis coefficient of the second power supply unit 230 may be calculated based on the surrounding environment information of the second power supply unit 230, and may correspond to a factor related to performance degradation of the second power supply unit 230 due to surrounding environment information.

A method for the second controller 250 to calculate the diagnosis coefficient of the second power supply unit 230 may be substantially the same as a method for the controller 150 to calculate the diagnosis coefficient of the power supply unit 130 in FIG. 1.

The second controller 250 may calculate the available limit of the second power supply unit 230 based on the diagnosis coefficient of the second power supply unit 230, the capacity of the second power supply unit 230, a consumed current required for the second communication unit 210 to transmit the speed information and/or the distance information to another electronic device, and the communication time of the second communication unit 210.

A method for the second controller 250 to calculate the available limit of the second power supply unit 230 may be substantially the same as a method for the controller 150 to calculate the available limit of the power supply unit 130 in FIG. 1.

When the second controller 250 calculates the available limit of the second power supply unit 230, Equation 1 of FIG. 1 may be referred to. In this case, in Equation 1, D may correspond to the available limit of the second power supply unit 230, C may correspond to the maximum capacity of the second power supply unit 230, I may correspond to a consumed current required for the second communication unit 210 to transmit the speed information and/or the distance information to another electronic device, K may correspond to the diagnosis coefficient of the second power supply unit 230, and T may correspond to the communication time of the second communication unit 210.

The second controller 250 may calculate an available limit of the second power supply unit 230 and control an operation of the second communication unit 210 based on the calculated available limit. The second controller 250 may determine whether the power supply unit 230 is drivable to control an operation of the second communication unit 210. More specifically, the second controller 250 may compare the calculated available limit with a third reference value and control an operation of the second communication unit 210 based on a comparison result. Herein, the third reference value may be set to the same value as the first reference value of FIG. 2, without being limited thereto.

According to an embodiment, the second controller 250 may determine that the second power supply unit 230 is drivable when the available limit of the second power supply unit 230 is equal to or greater than the third reference value. In this case, the second controller 250 may maintain the second communication period of the second communication unit 210.

According to another embodiment, the second controller 250 may increase the second communication period of the second communication unit 210 when the available limit of the second power supply unit 230 is less than the third reference value. When the available limit of the second power supply unit 230 is less than the reference value, this may correspond to a case where the second power supply unit 230 may not normally provide a driving power.

According to an embodiment, the second controller 250 may calculate the available limit of the second power supply unit 230 before the second communication unit 210 operates in the wakeup mode.

The second controller 250 may control an operation of the second communication unit 210 that may transmit the available limit of the second power source unit 230 to the other electronic device. According to an embodiment, the second communication unit 210 may transmit the available limit of the second power source unit 230 to the other electronic device only when the available limit of the second power source unit 230 is equal to or greater than the third reference value. According to a specific embodiment, the second communication unit 210 may transmit the available limit of the second power supply unit 230 to the server 1300.

The server 1300 may generate a second alert message when the available limit of the second power supply unit 230 is equal to or greater than the third reference value and is less than a fourth reference value. The server 1300 may transmit the second alert message to an operator. Herein, the fourth reference value may be set to the same value as the second reference value of FIG. 2, without being limited thereto. The second alert message may include available limit information of the second power supply unit 230. The second alert message may correspond to a message indicating that the battery position detection apparatus 200 is in a non-operation risk range. Herein, the non-operation risk range may mean a range in which the battery position detection apparatus 200 is likely to stop operating. The second alert message may correspond to a message requesting charge or replacement of the second power supply unit 230.

The second controller 250 may selectively include a processor, an ASIC, other chipsets, a logic circuit, a register, a communication modem, a data processing device, etc., known in this field to execute various control logics performed herein. Thus, when the control logic is implemented as software, the second controller 250 may be implemented as a group of program modules. In this case, the program module may be stored in a memory and may be executed by the second controller 250. The memory may be inside or outside the second controller 250 and may be connected to the second controller 250 by well-known various means.

The second storage unit 260 may store data or a program required for each component of the battery position detection apparatus 200 to perform an operation and a function of each component or data, etc., generated in a process of performing the operation and the function. The second storage unit 260 may not be specially limited to a specific type as long as it is a well-known information storage means known to record, erase, update, and read data. According to an embodiment, the information storage means may include RAM, flash memory, ROM, EEPROM, register, etc. In addition, the second storage unit 260 may store program codes where processes executable by the second controller 250 are defined.

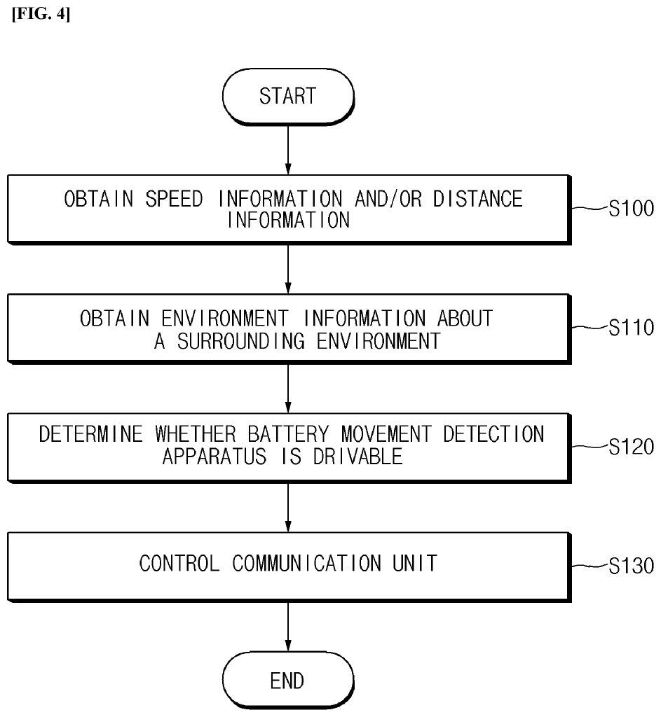

FIG. 4 is a flowchart illustrating an operating method of a battery monitoring system according to an embodiment disclosed herein.

Referring to FIG. 4, an operating method of a battery monitoring system may include operation S100 of obtaining speed information and/or distance information, operation S110 of obtaining surrounding environment information, operation S120 of determining whether an apparatus is drivable, and operation S130 of controlling a communication unit.

The operating method of the battery monitoring system will be described in detail with reference to FIGS. 1 to 3. According to an embodiment, each operation of the operating method of the battery monitoring system 1000 may be performed by the battery movement detection apparatus 1100 and/or the battery position detection apparatus 200.

Hereinbelow, a matter redundant to the foregoing matter described for convenience of a description will be omitted or briefly described.

In operation S100, the battery movement detection apparatus 1100 may obtain speed information. In this case, the speed information, which is the speed information of the battery movement detection apparatus 1100, may include acceleration information and/or angular speed information. An operation of obtaining the speed information may be performed by the speed sensor 1110.

In operation S100, the battery position detection apparatus 200 may obtain the distance information. In this case, the distance information may be distance information between the battery movement detection apparatus 1100 and the battery position detection apparatus 200. An operation of obtaining the distance information may be performed by the distance measurement unit 220.

In operation S110, the first environment sensor 1140 may obtain the surrounding environment information of the first power supply unit 1130. According to an embodiment, the first environment sensor 1140 may measure a temperature and/or humidity around the first power supply unit 1130.

In operation S110, the second environment sensor 240 may obtain the surrounding environment information of the second power supply unit 230. According to an embodiment, the second environment sensor 240 may measure a temperature and/or humidity around the second power supply unit 230.

In operation S120, the first controller 1150 may determine whether the battery movement detection apparatus 1000 is drivable. The first controller 1150 may determine whether the battery movement detection apparatus 1000 is drivable, based on the diagnosis coefficient of the first power supply unit 1130, the capacity of the first power supply unit 1130, a consumed current required for the first communication unit 1120 to transmit the speed information to another electronic device, and a communication time of the first communication unit 1120.

In operation S120, the second controller 250 may determine whether the battery position detection apparatus 200 is drivable. The second controller 250 may determine whether the battery movement detection apparatus 200 is drivable, based on the diagnosis coefficient of the second power supply unit 230, the capacity of the second power supply unit 230, a consumed current required for the second communication unit 210 to transmit the distance information and/or the speed information to the other electronic device, and a communication time of the second communication unit 210.

In operation S130, the first controller 1150 may control an operation of the first communication unit 1120 and the second controller 250 may control an operation of the second communication unit 210. According to an embodiment, the first controller 1150 may adjust the first communication period of the first communication unit 1120 and the second controller 250 may adjust the second communication period of the second communication unit 210.

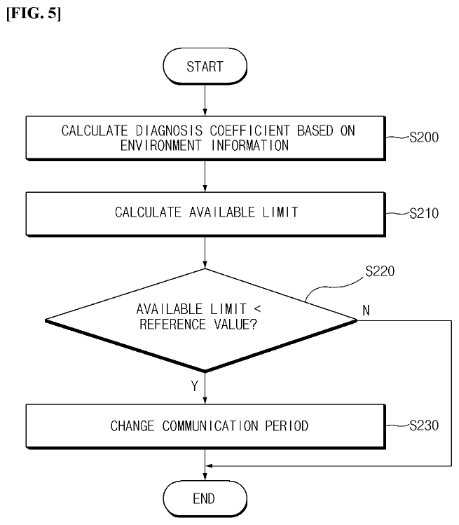

A detailed description of operations S120 and S130 will be described in detail with reference to FIG. 5.

FIG. 5 is a flowchart illustrating in detail an operating method of a battery monitoring system according to an embodiment disclosed herein.

Referring to FIG. 5, an operating method of a battery monitoring system may include operation S200 of calculating a diagnosis coefficient based on environment information, operation S210 of calculating an available limit, operation S220 of determining whether the available limit is less than a reference value, and operation S230 of changing a communication period when the available limit is less than the reference value.

Hereinbelow, the detailed operating method of the battery monitoring system will be described in detail with reference to FIGS. 1 to 4. Operations S200 to S220 may correspond to a detailed embodiment of operation S120 of FIG. 4, and operation S230 may correspond to a detailed embodiment of operation S130.

In operation S200, the first controller 1150 may calculate a diagnosis coefficient of the first power supply unit 1130 based on environment information obtained by the first environment sensor 1140 (e.g., temperature information and/or humidity information around the first power supply unit 1130).

In operation S200, the second controller 250 may calculate a diagnosis coefficient of the second power supply unit 230 based on environment information obtained by the second environment sensor 240 (e.g., temperature information and/or humidity information around the second power supply unit 230).

In operation S210, the first controller 1150 may measure a consumed current and a communication time required for the first communication unit 1120 to transmit the speed information to the other electronic device. In operation S210, the first controller 1150 may calculate the available limit of the first power supply unit 1130 based on the diagnosis coefficient of the first power supply unit 1130, the capacity of the first power supply unit 1130, a consumed current required for the first communication unit 1120 to transmit the speed information to the other electronic device, and the communication time of the first communication unit 1120.

In operation S210, the second controller 250 may measure a consumed current and a communication time required for the second communication unit 210 to transmit the speed information and/or the distance information to the other electronic device. In operation S210, the second controller 250 may calculate the available limit of the second power supply unit 230 based on the diagnosis coefficient of the second power supply unit 230, the capacity of the second power supply unit 230, a consumed current required for the second communication unit 210 to transmit the speed information and/or the distance information to another electronic device, and the communication time of the second communication unit 210.

In operation S220, the first controller 1150 may determine whether the available limit of the first power source unit 1130 is less than a preset reference value. According to an embodiment, the first controller 1150 may determine that the battery movement detection apparatus 1000 is drivable when the available limit of the first power supply unit 130 is equal to or greater than the reference value. In this case, the first power supply unit 1130 may maintain the first communication period of the first communication unit 1120. According to another embodiment, the first controller 1150 may determine that the battery movement detection apparatus 1000 is not drivable when the available limit of the first power supply unit 1130 is less than the reference value.

In operation S220, the second controller 250 may determine whether the available limit of the second power source unit 230 is less than the preset reference value. According to an embodiment, the second controller 250 may determine that the battery position detection apparatus 200 is drivable when the available limit of the second power supply unit 230 is equal to or greater than the reference value. In this case, the second power supply unit 230 may maintain the second communication period of the second communication unit 210. According to another embodiment, the second controller 250 may determine that the battery position detection apparatus 200 is not drivable when the available limit of the second power supply unit 230 is less than the reference value.

In operation S220, the first controller 1150 and the second controller 250 may set the same reference value to respectively determine whether the battery movement detection apparatus 1000 and the battery position detection apparatus 200 are drivable, without being limited thereto. For example, the first controller 1150 may determine based on the first reference value whether the battery movement detection apparatus 1000 is drivable, and the second controller 250 may determine based on the third reference value whether the battery position detection apparatus 200 is drivable.

In operation S230, the first controller 1150 may change the first communication period of the first communication unit 1120 when determining that the battery movement detection apparatus 1000 is not drivable, and may change the second communication period of the second communication unit 210 when determining that the battery position detection apparatus 200 is an embodiment not drivable. According to an embodiment, in operation S230, the first controller 1150 may increase the first communication period of the first communication unit 1120. According to an embodiment, in operation S230, the second controller 250 may increase the second communication period of the second communication unit 210.

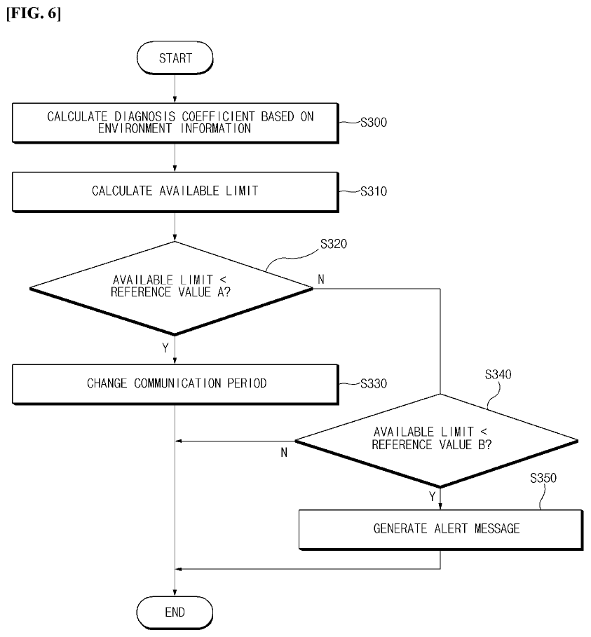

FIG. 6 is a flowchart illustrating in detail an operating method of a battery monitoring system according to an embodiment disclosed herein.

Referring to FIG. 6, an operating method of a battery monitoring system may include operation S300 of calculating a diagnosis coefficient based on environment information, operation S310 of calculating an available limit, operation S320 of determining whether the available limit is less than a first reference value, operation S330 of changing a communication period when the available limit is less than the first reference value, operation S340 of determining whether the available limit is less than the second reference value when the available limit is equal to or greater than the first reference value, and operation S350 of generating an alert message when the available limit is equal to or greater than the first reference value and is less than the second reference value.

Hereinbelow, the detailed operating method of the battery monitoring system will be described in detail with reference to FIGS. 1 to 5.

Operations S300 and S310 may be substantially the same as operations S200 and S210 of FIG. 5, respectively.

Operations S320 and S330 may be substantially the same as operations S220 and S230 of FIG. 5, respectively.

In operation S320, the first controller 1150 and the second controller 250 may compare the available limit of the first power supply unit 1130 and the available limit of the second power supply unit 230 with the first reference value and the third reference value, respectively. That is, in operation S320, a reference value a may mean the first reference value or the third reference value. According to an embodiment, the first reference value and the third reference value may be set to the same value, without being limited thereto.

The first controller 1150 may determine whether the available limit of the first power supply unit 1130 is less than the first reference value in operation S320, and change the first communication period of the first communication unit 1120 in operation S330 when the available limit of the first power supply unit 1130 is less than the first reference value.

The second controller 250 may determine whether the available limit of the second power supply unit 230 is less than the second reference value in operation S320, and change the communication period of the second communication unit 210 in operation S330 when the available limit of the second power supply unit 230 is less than the second reference value.

Operations S340 and S350 may be performed by the server 1300.

When the available limit of the first power supply unit 1130 is equal to or greater than the first reference value and/or the available limit of the second power supply unit 230 is equal to or greater than the third reference value, the server 1300 may perform operation S340.

In operation S340, the server 1300 may compare the available limit of the first power supply unit 1130 and the available limit of the second power supply unit 230 with the second reference value and the fourth reference value, respectively. That is, in operation S340, a reference value b may mean the second reference value or the fourth reference value. According to an embodiment, the second reference value and the fourth reference value may be set to the same value, without being limited thereto.

In operation S350, the server 1300 may generate the first alert message when determining in operation S340 that the available limit of the first power supply unit 1130 is equal to or greater than the first reference value and is less than the second reference value. In operation S350, the server 1300 may generate a second alert message when determining in operation S340 that the available limit of the second power supply unit 230 is equal to or greater than the third reference value and is less than the fourth reference value.

The first alert message generated in operation S350 may include available limit information of the first power supply unit 1130, and the second alert message may include available limit information of the second power supply unit 230.

Terms such as “include”, “constitute” or “have” described above may mean that the corresponding component may be inherent unless otherwise stated, and thus should be construed as further including other components rather than excluding other components. All terms including technical or scientific terms have the same meanings as those generally understood by those of ordinary skill in the art to which the embodiments disclosed herein pertain, unless defined otherwise. The terms used generally like terms defined in dictionaries should be interpreted as having meanings that are the same as the contextual meanings of the relevant technology and should not be interpreted as having ideal or excessively formal meanings unless they are clearly defined in the present document.

The above description is merely illustrative of the technical idea of the present disclosure, and various modifications and variations will be possible without departing from the essential characteristics of embodiments of the present disclosure by those of ordinary skill in the art to which the embodiments disclosed herein pertains. Therefore, the embodiments disclosed herein are intended for description rather than limitation of the technical spirit of the embodiments disclosed herein and the scope of the technical spirit of the present disclosure is not limited by these embodiments disclosed herein. The protection scope of the technical spirit disclosed herein should be interpreted by the following claims, and all technical spirits within the same range should be understood to be included in the range of the present document.

1. A battery movement detection apparatus comprising:
a speed sensor configured to obtain speed information of a tray accommodating a battery;
a power supply unit configured to provide a driving power;
an environment sensor configured to obtain environment information about a surrounding environment of the battery movement detection apparatus;
a communication unit configured to transmit the speed information to a battery position detection apparatus; and
a controller configured to calculate an available limit of the power supply unit based on the environment information and control an operation of the communication unit based on the available limit of the power supply unit.

2. The battery movement detection apparatus of claim 1, wherein the communication unit is further configured to transmit the speed information to the battery position detection apparatus in a communication period, and
wherein the controller is further configured to adjust the communication period based on the available limit of the power supply unit.

3. The battery movement detection apparatus of claim 1, wherein the speed sensor comprises at least one of an acceleration sensor and an angular speed sensor.

4. The battery movement detection apparatus of claim 1, wherein the environment information comprises at least one of temperature information and humidity information.

5. The battery movement detection apparatus of claim 2, wherein the controller is further configured to:
calculate a diagnosis coefficient based on the environment information; and
calculate the available limit of the power supply unit based on the diagnosis coefficient, a capacity of the power supply unit, a consumed current required for the communication unit to transmit the speed information to the battery position detection apparatus, and a communication time of the communication unit.

6. The battery movement detection apparatus of claim 5, wherein the controller is further configured to increase the communication period when the available limit of the power supply unit is less than a reference value.

7. A battery monitoring system comprising:
A battery movement detection apparatus;
a battery position detection apparatus; and
a server,
wherein the battery movement detection apparatus comprises:
a speed sensor configured to obtain speed information of a tray accommodating a battery;
a first power supply unit configured to provide a driving power;
a first environment sensor configured to obtain first environment information about a surrounding environment of the battery movement detection apparatus;
a first communication unit configured to transmit the speed information to the battery position detection apparatus; and
a first controller configured to calculate an available limit of the first power supply unit based on the first environment information and control an operation of the first communication unit based on the available limit of the first power supply unit, wherein the battery position detection apparatus comprises:
a distance measurement unit configured to obtain distance information with the battery movement detection apparatus; and
a second communication unit configured to transmit the speed information and the distance information to the server, and
wherein the server is configured to calculate an amount of impact of the battery movement detection apparatus based on the speed information and track a position of the battery movement detection apparatus based on the distance information.

8. The battery monitoring system of claim 7, wherein the first communication unit is further configured to transmit the speed information to the battery position detection apparatus in a first communication period, and
wherein the first controller is further configured to increase the first communication period when the available limit of the first power supply unit is less than a first reference value.

9. The battery monitoring system of claim 8, wherein the server is further configured to generate a first alert message when the available limit of the first power supply unit is equal to or greater than the first reference value and is less than a second reference value.

10. The battery monitoring system of claim 7, wherein the first controller is further configured to:
calculate a first diagnosis coefficient based on the first environment information; and
calculate the available limit of the first power supply unit based on the first diagnosis coefficient, a capacity of the first power supply unit, a consumed current required for the first communication unit to transmit the speed information to the battery position detection apparatus, and a communication time of the first communication unit.

11. The battery monitoring system of claim 7, wherein the battery position detection apparatus comprises:
a second power supply unit configured to provide a driving power;
a second environment sensor configured to obtain second environment information about a surrounding environment of the battery position detection apparatus; and
a second controller configured to calculate an available limit of the second power supply unit based on the second environment information and control an operation of the second communication unit based on the available limit of the second power supply unit.

12. The battery monitoring system of claim 11, wherein the second environment information comprises at least one of temperature information and humidity information.

13. The battery monitoring system of claim 11, wherein the second communication unit is further configured to transmit the speed information and the distance information to the server in a second communication period, and
wherein the second controller is further configured to adjust the second communication period based on the available limit of the second power supply unit.

14. The battery monitoring system of claim 13, wherein the second controller is further configured to:
calculate a second diagnosis coefficient based on the second environment information; and
calculate the available limit of the second power supply unit based on the second diagnosis coefficient, a capacity of the second power supply unit, a consumed current required for the second communication unit to transmit the speed information and the distance information to the server, and a communication time of the second communication unit.

15. The battery monitoring system of claim 14, wherein the second controller is further configured to increase the second communication period when the available limit of the second power supply unit is less than a third reference value.

16. The battery monitoring system of claim 15, wherein the server is further configured to generate a second alert message when the available limit of the second power supply unit is equal to or greater than the third reference value and is less than a fourth reference value.

17. An operating method of a battery movement detection apparatus, the operating method comprising:
obtaining speed information of a tray accommodating a battery;
obtaining surrounding environment information of the battery movement detection apparatus;
transmitting the speed information to another device in a communication period;
calculating an available limit of a power supply unit based on the surrounding environment information; and
adjusting the communication period based on the available limit of the power supply unit.

18. The operating method of claim 17, further comprising:
calculating a diagnosis coefficient based on the surrounding environment information; and
measuring a consumed current and a communication time required for transmitting the speed information to the another device,
wherein the available limit of the power supply unit is calculated based on the capacity of the power supply unit, the consumed current, the communication time, and the diagnosis coefficient.

19. The operating method of claim 18, further comprising increasing the communication period when the available limit of the power supply unit is less than a reference value.

20. The operating method of claim 17, wherein the speed information comprises at least one of acceleration information and angular speed information, and
wherein the surrounding environment information comprises at least one of temperature information and humidity information.
